(19) United States
(12) Patent Application Publication
(10) Pub. No.: US 2022/0341537 A1
(43) Pub. Date: Oct. 27, 2022

(54) COMPUTING DEVICE STANDS AND DISPLAY MOUNT INTERFACE SPACERS

(71) Applicant: Hewlett-Packard Development Company, L.P., Spring, TX (US)

(72) Inventors: Yao-Wen Fan, Taipei City (TW); Yu Wei Tan, Taipei City (TW); Yi Hsieh Chiu, Taipei City (TW)

(73) Assignee: Hewlett-Packard Development Company, L.P., Spring, TX (US)

(21) Appl. No.: 17/765,275

(22) PCT Filed: Nov. 6, 2019
(86) PCT No.: PCT/US2019/059993

§ 371 Date: Mar. 30, 2022

(51) Int. Cl. F16M 11/22; F16M 11/10

(52) U.S. Cl. CPC F16M 11/22; F16M 11/10; G06F 1/1607

(57) ABSTRACT

In some examples, an apparatus can include a body having a computing device stand structure for attachment of the body to a computing device and a display mount interface spacer structure for attachment of the body between a computing device and a display mount interface.

### BACKGROUND

Computing devices, such as thin client computing devices, can be attached to a display mount interface to allow the computing device to be used with a display but be somewhat hidden from view by viewers of the display. However, to do so, a user has to remove a display mount interface cover from the computing device when the user attaches the computing device to the display mount interface. But, when directly attached together, the outer surface of the computing device and a surface of the display mount interface contact each other and can cause scratches or other damage to the outer surface of the computing device.

### BRIEF DESCRIPTION OF THE DRAWINGS

FIG. 1A is an example of an apparatus having a computing device stand structure consistent with the disclosure.

FIG. 1B is an example of an apparatus having a display mount spacer structure consistent with the disclosure.

FIG. 2A is an angled view of an example of a computing device stand structure attached to a bottom surface of a computing device consistent with the disclosure.

FIG. 2B is a side view of an example of a computing device stand structure attached to a bottom surface of a computing device consistent with the disclosure.

FIG. 2C is a cutaway close-up view of an example of the attachment between the computing device stand structure and the bottom surface of a computing device consistent with the disclosure.

FIG. 3 is an example of a computing device with a cover removed to provide a view of the apertures and surface features that can be used to attach the apparatus to the computing device as a spacer or a stand consistent with the disclosure.

FIG. 4A is an angled view of an example of a computing device stand structure attached to a side surface of a computing device consistent with the disclosure.

FIG. 4B is a cutaway close-up view of an example of the attachment between the computing device stand structure and the side surface of a computing device consistent with the disclosure.

FIG. 4C is a front view of an example of a computing device stand structure attached to a side surface of a computing device consistent with the disclosure,

FIG. 5A is a side angled view of an example of a display mount interface spacer structure attached to a side surface of a computing device consistent with the disclosure,

FIG. 5B is a front view of an example of a display mount interface spacer structure attached to a side surface of a computing device consistent with the disclosure.

FIG. 6A is an example of a display mount interface consistent with the disclosure.

FIG. 6B is an angled view of an example of a display mount interface attached to a computing device with a spacer structure provided therebetween consistent with the disclosure.

FIG. 6C is a cutaway close-up view of an example of a display mount interface attached to a computing device with a spacer structure provided therebetween consistent with the disclosure.

FIG. 6D is a front view of an example of a display mount interface attached to a computing device with a spacer structure provided therebetween consistent with the disclosure.

FIG. 7A is an angled view of an example of a second type of display mount interface attached to a computing device with a spacer structure provided therebetween consistent with the disclosure.

FIG. 7B is a front view of an example of a second type of display mount interface attached to a computing device with a spacer structure provided therebetween consistent with the disclosure.

### DETAILED DESCRIPTION

The present disclosure provides an apparatus that can be used with a computing device in multiple configurations and systems having a stand/spacer apparatus and a computing device. This allows the computing device to be used in several different configurations without the added cost of purchasing a stand and/or spacer and reduces materials costs, as the apparatus has several functional configurations in which it can be used, instead of designing multiple different devices to provide these functions, among other benefits.

The apparatuses and systems described herein can have several functions. For instance, in some examples, an apparatus can include a body having a computing device stand structure for attachment of the body to a computing device and a display mount interface spacer structure for attachment of the body between a computing device and a display mount interface.

In the following detailed description of the present disclosure, reference is made to the accompanying drawings that form a part hereof, and in which is shown by way of illustration how one or more examples of the disclosure may be practiced. These examples are described in sufficient detail to enable those of ordinary skill in the art to practice the examples of this disclosure, and it is to be understood that other examples may be utilized, and that process and/or structural changes may be made without departing from the scope of the present disclosure.

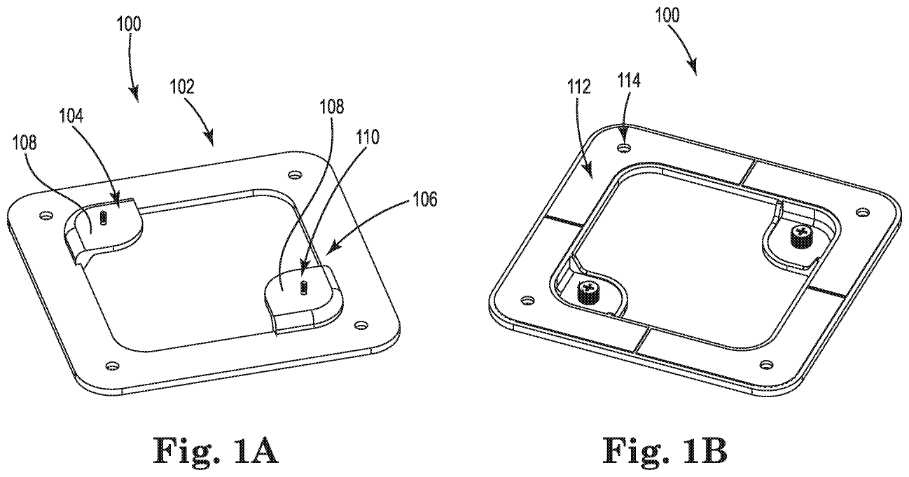

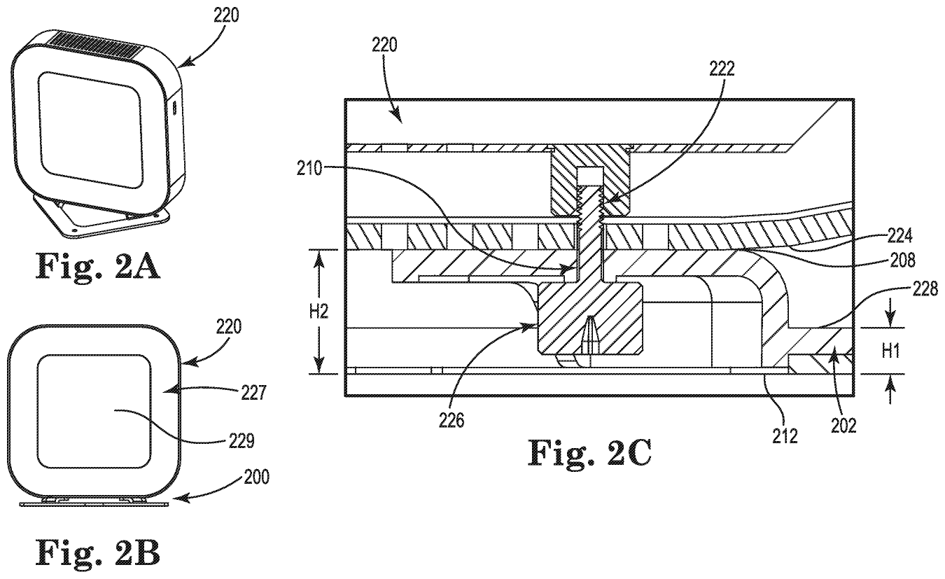

The figures herein follow a numbering convention in which the first digit or digits correspond to the figure number of the drawing and the remaining digits identify an element or component in the drawing. Similar elements or components between different figures may be identified by the use of similar digits. For example, reference numeral 112 may reference element “12” in FIG. 1B, and a similar element may be referenced as 212 in FIG. 2C.

Further, the stand/spacer apparatus example provided herein can be used in several orientations with respect to a computing device where the computing device is in an upright, lying down, or attached to a display mount or display mount interface. In describing the differences between these orientations, the description uses the terms “front”, “side”, and “bottom” to assist the reader in interpreting how the computing device and the stand/spacer apparatus are oriented in the attached drawings. However, such terms should not be viewed as limiting the orientation of the examples provided herein.

FIG. 1A is an example of an apparatus having a computing device stand structure consistent with the disclosure, FIG. 1B is an example of an apparatus having a display mount spacer structure consistent with the disclosure. In the example of FIGS. 1A and 1B, the functional features providing the computing device stand structure and the display mount spacer structure are provided on a single apparatus 100.

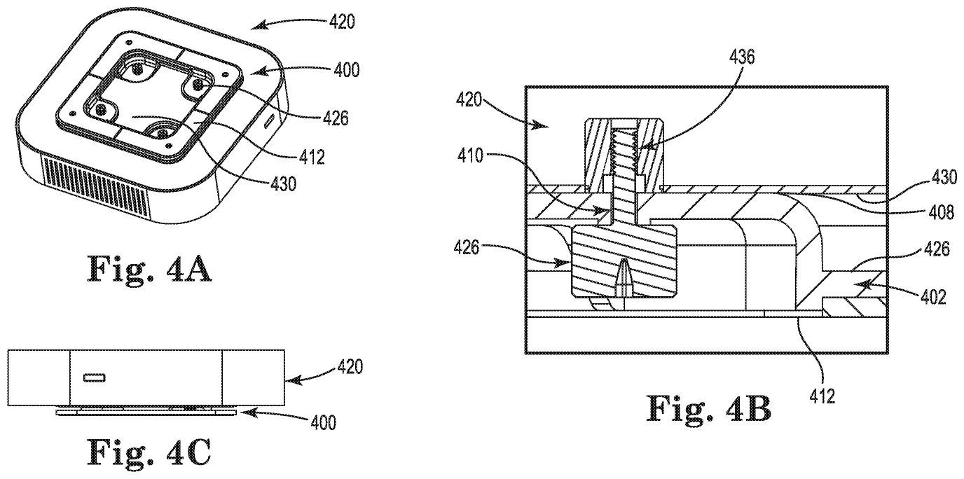

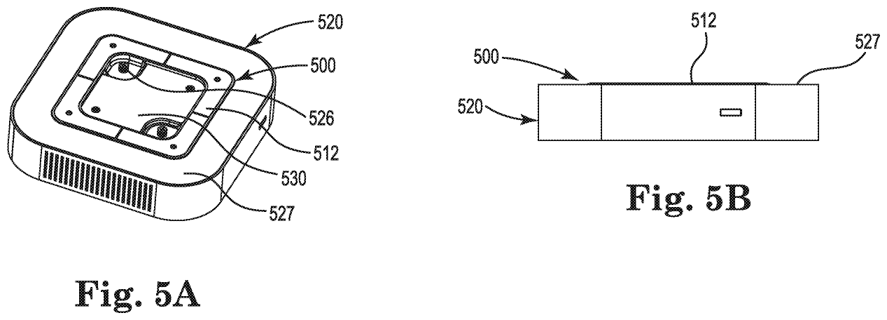

The apparatus 100 of FIGS. 1A and 1B includes a body having a computing device stand structure (features of which are generally located on a first side of the apparatus 100 in FIG. 1A) for attachment of the body to a computing device (e.g., a thin client computing device), as further shown and described with respect to FIGS. 2A-2C and 4A-4C. The apparatus 100 also includes a display mount interface spacer structure (features of which are generally located on a second side of the apparatus 100 in FIG. 1B) for attachment of the body between a computing device and a display mount interface, as further shown and described with respect to FIGS. 5A-7B.

In FIG. 1A, the computing device stand structure includes a base portion 102 and a connection portion (the connection portion provided by first and second raised portions 104 and 106 although more or less structures can be used). The base portion 102 can be used to place the computing device on a surface, such as a working surface of a desk or table. The connection portion can be used to connect the apparatus when used as a stand to the computing device as will be described in further detail below.

As discussed above, the connection portion of the computing device stand structure includes a first raised portion 104 that contacts a first portion of a computing device and a second raised portion 106 that contacts a second portion of the computing device. These first and second raised portions each have a first surface 108 that is to contact an outer surface of the computing device when the stand/spacer apparatus 100 is used as a computing device stand and wherein the first surface 108 is used to contact the computing device when the apparatus 100 is used as a display mount interface spacer.

The first surfaces (on raised portions 104 and 106) include a mechanism to attach the apparatus 100 to a computing device. Any suitable mechanism can be utilized. For example, in FIG. 1A, the first surfaces 108 each has an aperture 110 thereon. These apertures contain a screw that can be screwed in to a corresponding aperture in the body of the computing device. This fastening system is shown and described in more detail with respect to FIG. 20.

In the example of FIG. 1B, the apparatus 100 is turned upside-down from the view shown in FIG. 1A and, so, the base is now higher than the raised portions 104 and 106. In this manner, when installed between a computing device and a display mount interface, the apparatus acts as a spacer. The spacing functionality is provided because the first surface 108 is spaced apart from a second surface 112 that is to attach to the display mount interface via apertures 114 provided in the base portion 102 thereby providing a space between the computing device and display mount or display mount interface.

FIG. 2A is an angled view of an example of a computing device stand structure attached to a bottom surface of a computing device consistent with the disclosure. In FIG. 2A and several other figures herein, the computing device illustrated is a thin client computing device. And, although discussed with regard to the figures as being used with a thin client computing device, the reader should understand that such a stand/spacer apparatus can be utilized with other types of computing devices.

FIG. 2B is a side view of an example of a computing device stand structure attached to a bottom surface of a computing device consistent with the disclosure. And, FIG. 2C is a cutaway close-up view of an example of the attachment between the computing device stand structure and the bottom surface of a computing device consistent with the disclosure.

In the example of FIGS. 2A-20, a computing device 220 is attached at its bottom surface to the apparatus 200. This allows the computing device to be more securely placed on a surface, such as a working surface of a desk or table, since the apparatus is wider than the bottom surface of the computing device in its installed configuration.

As shown in FIG. 20, one way of securing the computing device 220 to the apparatus 200 is to provide an aperture 210 on the first surface 208 of the connection portion that corresponds to an aperture 222 on the bottom surface 224 of the computing device and affix a fastener 226 (e.g., a screw) through the two apertures 208 and 222. In this manner, the computing device and the apparatus in this stand configuration are securely fixed together. Although FIG. 2C shows a single set of apertures and a fastener, the reader should note that one or more additional sets of apertures and fasteners may be utilized as is shown in FIGS. 1A and 1B.

FIG. 2C also shows the different heights between the second surface 212 of the base portion 202 (bottom surface of the body in the arrangement shown in FIG. 2C) and a top surface 228 of the base portion 202 having height h1 and from the second surface 212 to the first surface 208 having height h2. These heights will be discussed in more detail with regard to how they provide sufficient space when the apparatus is utilized as a spacer.

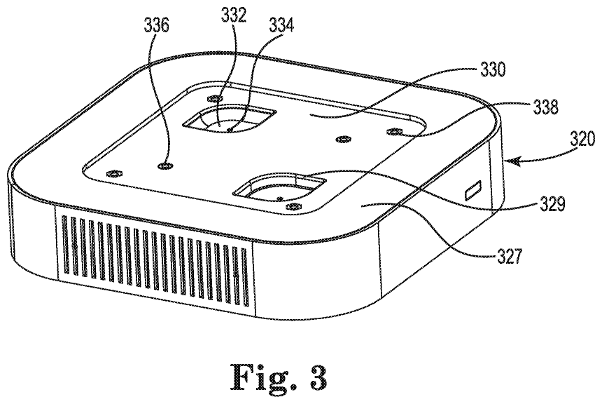

FIG. 2B also illustrates an example of a computing device that has a cover 229 on its side surface 227. This cover will be removed in FIG. 3 to identify some features of this computing device that are complimentary to the shapes of structures of an apparatus of the present disclosure (e.g., apparatus 100 of FIGS. 1A and 1B). These features allow for the use of the stand/spacer apparatus as a spacer and stand and can make the connections between the apparatus and computing device or display mount or display mount interface more secure and/or stronger, among other benefits.

FIG. 3 is an example of a computing device with a cover removed to provide a view of the apertures and surface features that can be used to attach the apparatus to the computing device as a spacer or a stand consistent with the disclosure. In the example of FIG. 3, the computing device 320 has been laid down on one side (as in contrast to the upright configuration shown in FIG. 2B) so that the cover can be removed from the other side 327 and attachment of the stand/spacer apparatus can be accomplished.

FIG. 3 shows a set of apertures 336 that can be used to attach the apparatus for use as a stand in a configuration where the computing device is laid on its side (as shown in FIGS. 4A-4C). Attachment of the stand/spacer apparatus to this set of apertures will be similar to the attachment arrangement shown in FIG. 2C (i.e., a fastener placed through apertures 210 and into corresponding apertures 336 to secure the apparatus to the side interior surface 330).

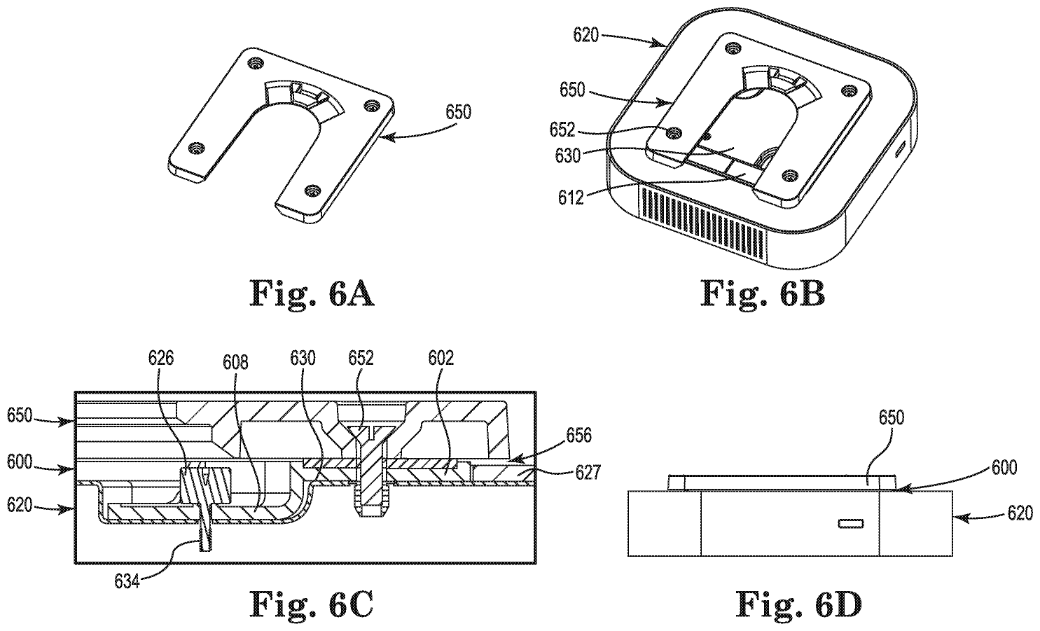

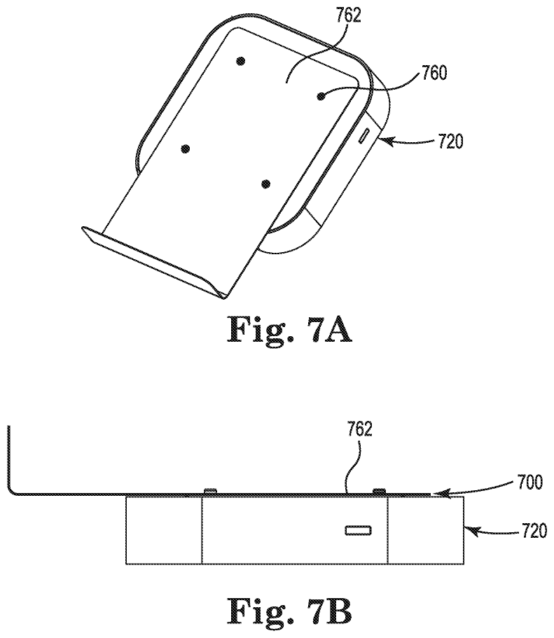

FIG. 3 also shows a set of apertures 338 that correspond with apertures on the base portion (e.g., apertures 114 of FIG. 1B) for use of the stand/spacer apparatus as a spacer as shown in FIGS. 6A-7B. FIG. 3 also has apertures 334 that correspond with the apertures (e.g., apertures 110 of FIG. 1A) on the first surface when the apparatus is used as a spacer.

Further, FIG. 3 also shows a shaped area of the side interior surface 330 having shapes 332 and 329 that mate with shapes of the connection portion. These shapes can create a more secure affixation between the stand/spacer apparatus and the computing device when the apparatus is used as a spacer. For example, the top surface of the connection portion (e.g., first surface 108 as described with respect to FIG. 1A) can have a shape that mates with a corresponding shape 332 on the computing device 320. In some examples, the connection portion has at least one side surface, and the side surface has a shape that mates with a corresponding shape 329 on the computing device 320. This can be seen when comparing the surface 329 with the side surface of the connection portion of FIG. 1A.

FIGS. 4A-4C provide an illustration of an example use of a computing device having a side mounted stand structure according to the disclosure. FIG. 4A is an angled view of an example of a computing device stand structure attached to a side surface of a computing device consistent with the disclosure. FIG. 4B is a cutaway close-up view of an example of the attachment between the computing device stand structure and the side surface of a computing device consistent with the disclosure. FIG. 4C is a front view of an example of a computing device stand structure attached to a side surface of a computing device consistent with the disclosure.

FIG. 4A shows the features of the stand structure of the apparatus 400 affixed to the interior side surface 430 of the computing device 420. Fasteners 426 are used to make the attachment in this example. Once affixed, the computing device is rotated right side up such that second surface 412 on the base 402 of apparatus 400 is used to place the computing device on a flat working surface, such as a desktop or table, as shown in FIG. 4C.

FIG. 4B provides a closer view of the attachment structure provided in the example shown in FIGS. 4A-40. In the example of FIGS. 4A-40, a computing device 420 is attached at its interior side surface (cover has been removed) to the stand/spacer apparatus 400. This allows the computing device to be more securely placed on a surface, such as a working surface of a desk or table, since the computing device can be laid down making it less likely to tip over, among other benefits.

As shown in FIG. 4C, one way of securing the computing device 420 to the apparatus 400 is to provide an aperture 410 on the first surface 408 of the connection portion that corresponds to an aperture 436 on the interior side surface 430 of the computing device and affix a fastener 426 (e.g., a screw) through the two apertures 408 and 436. In this manner, the computing device and the apparatus when used as a stand are securely fixed together. Although FIG. 40 shows a single set of apertures and a fastener, the reader should note that one or more additional sets of apertures and fasteners may be utilized as is shown in FIGS. 1A and 1B.

FIG. 4C also shows the different heights between the second surface 412 of the base portion 402 and a top surface of the base portion 402 having a first height and from the second surface 412 to the first surface 408 having a second height. As can be seen in FIG. 4C, these heights are used to define how high off a working surface the computing device is positioned. As shown, such a height above the working surface can provide for greater airflow around the computing device and may reduce the possibility of the body of the computing device from being scratched or otherwise damaged, among other benefits.

FIGS. 5A and 5B provide an illustration of an example use of a computing device having a side mounted spacer structure according to the disclosure. FIG. 5A is a side angled view of an example of a display mount interface spacer structure attached to a side surface of a computing device consistent with the disclosure. FIG. 5B is a front view of an example of a display mount interface spacer structure attached to a side surface of a computing device consistent with the disclosure.

FIG. 5A shows the features of the spacer structure of the stand/spacer apparatus 500 affixed to the interior side surface 530 of the computing device 520. Fasteners 526 are used to make the attachment in this example.

In this example, the connection portion (e.g., raised portions 104 and 106 of FIG. 1A) is rotated and placed such that the first surfaces (108 of FIG. 1A) are placed in contact with the shaped surfaces (332 of FIG. 3). As discussed with respect to FIG. 3, the surfaces of the connection portion and these surfaces of the interior side of the computing device can be designed to mate with each other to more securely affix the computing device 520 and the apparatus 500.

Once affixed, due to the attachment of the spacer as shown in FIGS. 5A and 5B (and the heights of different surfaces of the apparatus as described with respect to the example of FIG. 2C), the surface 512 of the apparatus 500 is positioned higher than the surface of side 527 of the computing device 520, as shown in FIG. 5B. This arrangement can then be mounted directly to a mount for a display or can be affixed to a display mount interface as discussed with respect to FIGS. 6A-6D.

FIGS. 6A-6D provide an illustration of an example use of a computing device having a side mounted spacer structure affixed to a display mount interface according to the disclosure. FIG. 6A is an example of a display mount interface consistent with the disclosure. FIG. 6B is an angled view of an example of a display mount interface attached to a computing device with a spacer structure provided therebetween consistent with the disclosure, FIG. 6C is a cutaway close-up view of an example of a display mount interface attached to a computing device with a spacer structure provided therebetween consistent with the disclosure. FIG. 6D is a front view of an example of a display mount interface attached to a computing device with a spacer structure provided therebetween consistent with the disclosure.

As discussed above, the computing device with the stand/spacer apparatus providing a spacer structure as shown in FIGS. 5A and 5B can be installed directly to a mount of a display or can be affixed to a display mount interface. A first type of interface 650 is shown in FIG. 6A and a second type of interface is shown in FIG. 7A. The apparatus of this disclosure can be utilized with either of these types of interfaces.

In the example shown in FIG. 6B, the computing device 620 has the display mount interface 650 attached to the surface 612 and interior side 630 of the computing device via fasteners 652. FIG. 6C provides a closer view of the connection of the display mount interface 650, the stand/spacer apparatus 600, and the computing device 620.

As can be seen in this view, the apparatus 600 can be affixed through surface 608 to the computing device 620 via a fastener 626 in aperture 634 of interior side 630. This can be accomplished, for example, by having a plurality of apertures in the base portion that are arranged to correspond to apertures located on the display mount interface.

Further, the display mount interface can be affixed to the apparatus 600 used in a spacer configuration and, in some instances, also to the computing device (as shown in the example of FIG. 6C. This can be accomplished, for example, via a fastener 652 where the fastener passed through apertures that are aligned in the base portion of the apparatus and the interior side of the computing device.

Also, as can be seen from the view of FIG. 6C, the base 602 has a height that is higher than the side 627 of the computing device, thereby creating a space 656 between the display mount interface 650 and the side 627 of the computing device 620. This can be accomplished, for example, by having the display mount interface spacer structure of the apparatus 600 dimensioned such that when the spacer structure is attached between the computing device 620 and the display mount interface 650, an outer surface (e.g., outer surface of side 627) of the computing device 620 is not in contact with the display mount interface 650. In this manner, the possibility of damage to the surface of body of the computing device during the installation, use, and/or removal of the display mount interface is reduced, among other benefits of such an example.

FIGS. 7A and 7B illustrate a second type of display mount interface that can be utilized with the apparatus of this disclosure. FIG. 7A is an angled view of an example of a second type of display mount interface attached to a computing device with the apparatus providing a spacer structure therebetween consistent with the disclosure. FIG. 7B is a front view of an example of a second type of display mount interface attached to a computing device with the apparatus providing a spacer structure therebetween consistent with the disclosure.

In the example shown in FIGS. 7A and 7B, the computing device 720 has the display mount interface 762 attached to the stand/spacer apparatus 700 via fasteners 760. In some implementations, the fasteners can extend into the interior side of the computing device in a similar manner to the fastener 652 shown in FIG. 6C.

Also, as can be seen from the view of FIG. 78, the apparatus 700 dimensioned such that when the apparatus is used as a spacer structure is attached between the computing device 720 and the display mount interface 762, the computing device 720 is not in contact with the display mount interface 762. In this manner, the possibility of damage to the surface of body of the computing device during the installation, use, and/or removal of the display mount interface is reduced, among other benefits of such an example.

It is to be understood that the terminology used herein is for the purpose of describing particular examples only and is not intended to be limiting. As used herein, the singular forms “a”, “an”, and “the” include singular and plural referents, unless the context clearly dictates otherwise, as do “a number of”, “at least one”, and “one or more” (e.g., a number of apertures may refer to one or more apertures whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to”.

Although specific examples have been illustrated and described herein, those of ordinary skill in the art will appreciate that an arrangement calculated to achieve the same results may be substituted for the specific examples shown. This disclosure is intended to cover adaptations or variations of one or more examples of the present disclosure.

It is to be understood that the above description has been made in an illustrative fashion, and not a restrictive one. Combination of the above examples, and other examples not specifically described herein will be apparent to those of skill in the art upon reviewing the above description.

The scope of the one or more examples of the present disclosure includes other applications in which the above structures and processes are used. Therefore, the scope of one or more examples of the present disclosure should be determined with reference to the appended claims, along with the full range of equivalents to which such claims are entitled.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim.

Rather, as the following claims reflect, inventive subject matter lies in less than all features of a single disclosed example. Thus, the following claims are hereby incorporated into the Detailed Description, with each claim standing on its own.

What is claimed is:

1. An apparatus, comprising:
a body having:
a computing device stand structure for attachment of the body to a computing device; and
a display mount interface spacer structure for attachment of the body between the computing device and a display mount interface.

2. The apparatus of claim 1, wherein the computing device stand structure includes a first raised portion that contacts a first portion of the computing device and a second raised portion that contacts a second portion of the computing device.

3. The apparatus of claim 1, wherein the display mount interface spacer structure is dimensioned such that when the spacer structure is attached between the computing device and the display mount interface, an outer surface of the computing device is not in contact with the display mount interface.

4. The apparatus of claim 1, wherein the body has a first surface that is to contact an outer surface of the computing device when the apparatus is used as a computing device stand and wherein the first surface is also used to contact the computing device when the apparatus is used as a display mount interface spacer.

5. The apparatus of claim 4, wherein the first surface is spaced apart from a second surface that is to attach to the display mount interface.

6. An apparatus, comprising:
a body having a base portion and a connection portion, the connection portion having:
a computing device stand structure for attachment of the body to a computing device; and
a display mount interface spacer structure for attachment of the body between the computing device and a display mount interface.

7. The apparatus of claim 6, wherein the base portion has a plurality of apertures arranged to correspond to apertures located on the display mount interface.

8. The apparatus of claim 6, wherein the connection portion has a plurality of apertures arranged to correspond to apertures located on a surface of the computing device.

9. The apparatus of claim 6, wherein the connection portion has a plurality of apertures arranged to correspond to apertures located on a bottom surface of the computing device.

10. The apparatus of claim 9, wherein the connection portion has a plurality of apertures arranged to correspond to apertures located on a side surface of the computing device.

11. The apparatus of claim 6, wherein the connection portion has a plurality of apertures arranged to correspond to apertures located on a side surface of the computing device.

12. A system, comprising:
a computing device;
a stand/spacer apparatus having a body with a base portion and a connection portion, wherein the body has a height dimension and wherein a top surface of the base portion has a first height from a bottom surface of the body and a top surface of the connection portion has a second height from the bottom surface of the body and wherein the second height is different from the first height, the connection portion having:
a computing device stand structure for attachment of the body to the computing device; and
a display mount interface spacer structure for attachment of the body between the computing device and a display mount interface.

13. The system of claim 12, wherein the top surface of the connection portion has a shape that mates with a corresponding shape on the computing device.

14. The system of claim 13, wherein the connection portion has at least one side surface and wherein the side surface has a shape that mates with a corresponding shape on the computing device.

15. The system of claim 12, wherein the connection portion has at least one side surface and wherein the side surface has a shape that mates with a corresponding shape on the computing device.
